(19) United States
(12) Patent Application Publication
(10) Pub. No.: US 2010/0045605 A1
(43) Pub. Date: Feb. 25, 2010

(54) KEYBOARD FOR A SMALL FORM FACTOR DATA PROCESSING APPARATUS

(76) Inventor: R. Scott Bartlett, Oakland, CA (US)

Correspondence Address: MICROSOFT CORPORATION, ONE MICROSOFT WAY, REDMOND, WA, 98052, US

(21) Appl. No.: 12/194,460

(22) Filed: Aug. 19, 2008

(51) Int. Cl. G06F 3/02

(52) U.S. Cl. 345/168

(57) ABSTRACT

A keyboard apparatus for a small form factor data processing device. For example, a data processing device is described comprising: a body having a memory for storing program code and data and a processor for processing the program code and data, the body further comprising a keyboard defining a first plane, the keyboard having a plurality of keys selectable by a user; a display having a surface defining a second plane, the display moveably coupled to the data processing device to move from a first position in which the display covers the keyboard to a second position in which the keyboard is exposed, wherein the first plane and the second plane remain substantially parallel as the display is moved from the first position to the second position; and wherein the keyboard comprises a plurality of holes formed in the body, and a corresponding plurality of keys operatively coupled to the body and immersed within each one of the holes, wherein the width and length of each hole is sized to provide sufficient spacing to accommodate the tip of a user's thumb as a key is depressed by the user into the hole.

### BACKGROUND OF THE INVENTION

1. Field of the Invention

This invention relates generally to the field of data processing devices. More particularly, the invention relates to an improved keyboard design for a portable data processing apparatus.

2. Description of the Related Art

Portable data processing devices such as Personal Digital Assistants (“PDAs”) and programmable wireless telephones are becoming more powerful every day, providing users with a wide range of applications previously only available on personal computers. At the same time, due to advances in silicon processing technology and battery technology, these devices may be manufactured using smaller and smaller form factors. Accordingly, users no longer need to sacrifice processing power for portability when selecting a personal data processing device.

Although processing devices with small form factors tend to be more portable, users may find it increasingly difficult to interact with them. For example, entering data may be difficult due to the absence of a full-sized keyboard and reading information may be difficult due to a small, potentially dim Liquid Crystal Display (“LCD”).

To deal with this problem, devices have been designed with displays that adjust from a first position in which the display covers an alphanumeric keyboard, to a second position in which the alphanumeric keyboard is exposed. For example, the display of the T-Mobile Sidekick pivots open to expose a full alphanumeric keyboard which may be used for text entry. The display is viewable in both the first position and the second position.

### SUMMARY

A keyboard apparatus for a small form factor data processing device. For example, a data processing device according to one embodiment of the invention comprises: a body having a memory for storing program code and data and a processor for processing the program code and data, the body further comprising a keyboard defining a first plane, the keyboard having a plurality of keys selectable by a user; a display having a surface defining a second plane, the display moveably coupled to the data processing device to move from a first position in which the display covers the keyboard to a second position in which the keyboard is exposed, wherein the first plane and the second plane remain substantially parallel as the display is moved from the first position to the second position; and wherein the keyboard comprises a plurality of holes formed in the body, and a corresponding plurality of keys operatively coupled to the body and immersed within each one of the holes, wherein the width and length of each hole is sized to provide sufficient spacing to accommodate the tip of a user's thumb as a key is depressed by the user into the hole.

### BRIEF DESCRIPTION OF THE DRAWINGS

A better understanding of the present invention can be obtained from the following detailed description in conjunction with the following drawings, in which:

FIGS. 1a-c illustrate a prior art data processing device with an adjustable display.

FIGS. 2a-b illustrate another prior art data processing device with an adjustable display.

FIG. 3 illustrates a keyboard employed in a prior data processing apparatus.

FIG. 4 illustrates a keyboard according to one embodiment of the invention.

FIG. 5 illustrates a key from a side view according to one embodiment of the invention.

### DETAILED DESCRIPTION OF PREFERRED EMBODIMENTS

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Several different multi-purpose input/output and display configurations for a data processing device are described below. As will be apparent from the following description, many of these configurations are particularly beneficial when employed on a dual-purpose data processing device such as a personal digital assistant (“PDA”) or other mobile computing device having integrated wireless telephony capabilities (e.g., a combination PDA and cell phone). However, it should be noted that the underlying principles of the invention are not limited to wireless telephony configuration.

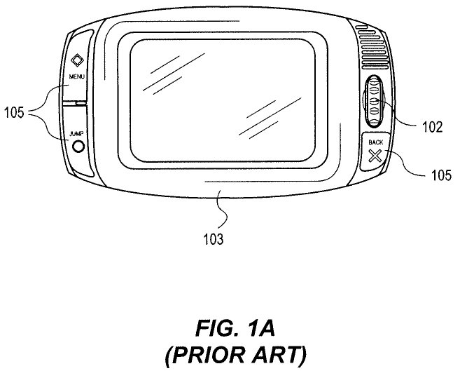

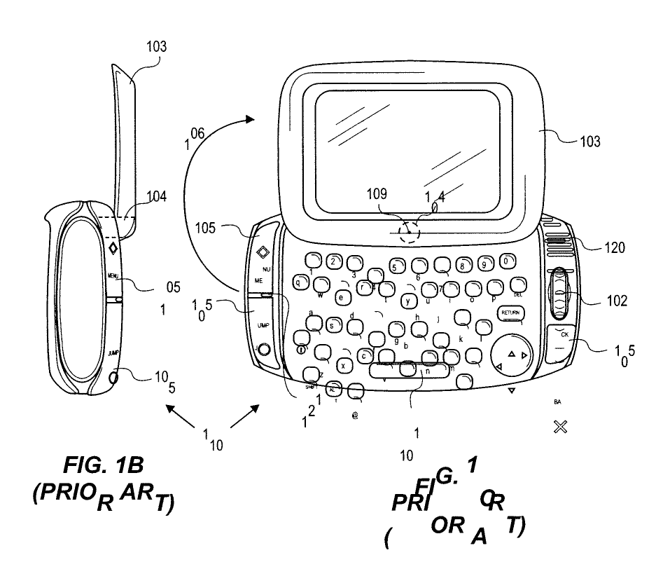

To solve these problems, the assignee of the present application developed a data processing device 100 with an adjustable display 103 as illustrated in FIGS. 1a-c. The data processing device 100 includes a keyboard 101, a control knob/wheel 102 (e.g., for scrolling between menu items and/or data), and a set of control buttons 105 (e.g., for selecting menu items and/or data).

The display 103 is pivotally coupled to the data processing device 100 and pivots around a pivot point 109, located within a pivot area 104, from a first position illustrated in FIG. 1a to a second position illustrated in FIGS. 1b-c. When in the first position the display 103 covers the keyboard 101, thereby decreasing the size of the device 100 and protecting the keyboard 101. Even when the display is in the first position, however, the control knob 102 and control buttons 105 are exposed and therefore accessible by the user. The motion of the display 103 from the first position to a second position is indicated by motion arrow 106 illustrated in FIGS. 1a-b. As illustrated, when in the second position, the keyboard 101 is fully exposed. Accordingly, the display is viewable, and data is accessible by the user in both a the first position and the second position (although access to the keyboard is only provided in the first position).

The data processing device 100 is also provided with audio telephony (e.g., cellular) capabilities. To support audio telephony functions, the embodiment illustrated in FIGS. 1a-c includes a speaker 120 for listening and a microphone 121 for speaking during a telephone conversation. Notably, the speaker 120 and microphone 121 are positioned at opposite ends of the data processing device 100 and are accessible when the screen 103 is in a closed position and an open position.

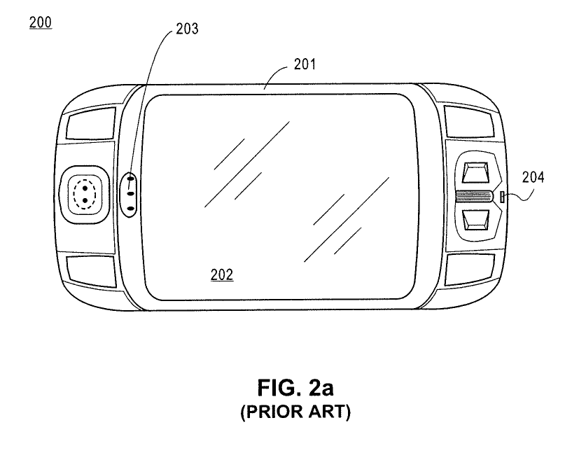

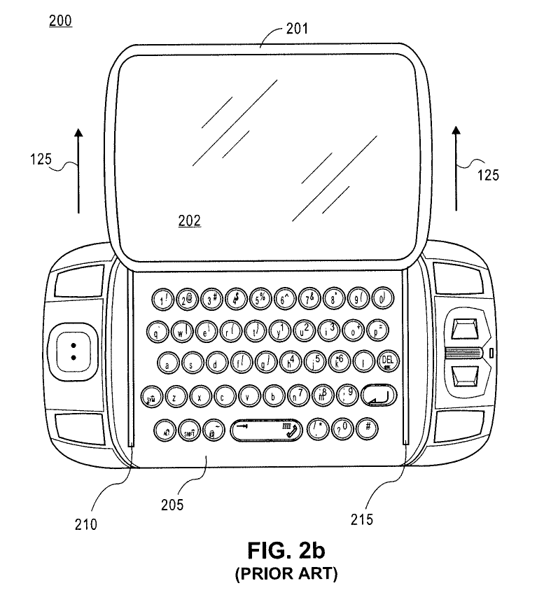

Another embodiment of an adjustable display is illustrated in FIGS. 2a-b. The data processing device 200 includes a display 201 with a viewable display area 202 for displaying various types of text and graphics. Moreover, as in the embodiments described above, the data processing device 200 also includes a plurality of different modes of operation which may be associated with a respective plurality of display and/or device orientations. In the first mode of operation, the display is viewed in a first position, illustrated generally in FIG. 2a in which it covers an alphanumeric keyboard 205 (illustrated in FIG. 2b). In this first position, the display is located flush within the boundary defined by the non-display portions of the data processing device 200.

By contrast, the display is illustrated in a second position in FIG. 2b, in which the alphanumeric keyboard 205 is exposed and usable for data entry. In one embodiment, the second position of the display corresponds to a second mode of operation. As shown in FIG. 2b, in this embodiment, the display slides from the first position to the second position in a direction substantially parallel to a plane defined by the front surface of the data processing device 200, as indicated by motion arrows 125. The sliding motion may be accomplished via pins or posts (not shown) on the backside of the display that are engaged with tracks 210, 215 located on the face of the data processing device to the left and right of the alphanumeric keyboard 205, respectively. Of course, various other known mechanisms for sliding a display may be used while still complying with the underlying principles of the invention.

In each of the embodiments described above, the lower surface of the display is positioned directly above the exposed face of the keyboard when the display is covering the keyboard. Thus, as the display is moved from one position to the next, a plane defined by the lower surface of the display moves substantially parallel to a plane defined by the exposed face of the keyboard. To maintain the small size of the data processing device, it is desirable to keep the space between these planes as small as possible.

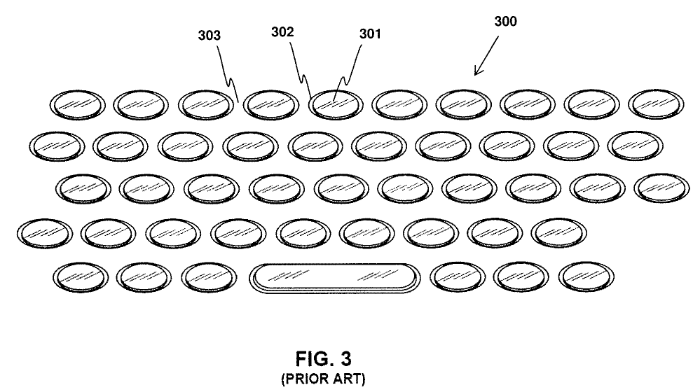

As illustrated in FIG. 3, in order to reduce the spacing in a typical prior art keyboard, the top of each key 301 on the keyboard is made flat and co-planar with the non-moveable surface of the keyboard 303. The keys of this keyboard, however, may be difficult to depress because of the small spacing 302 between each key 301 and the keyboard surface 303.

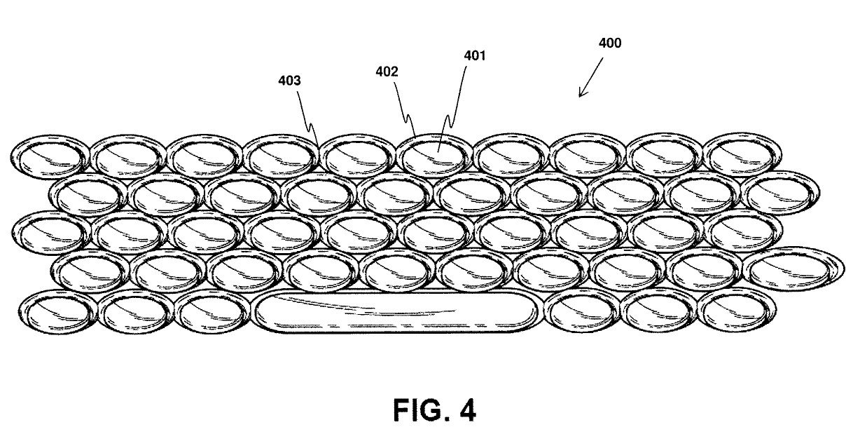

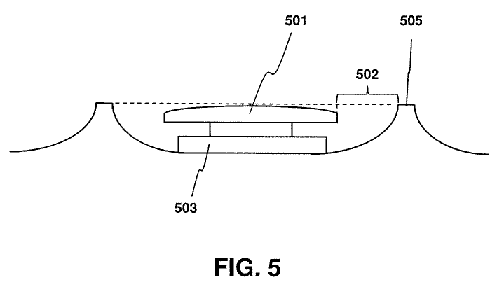

FIGS. 4 and 5 illustrate one embodiment of the invention which maintains a relatively small spacing between a keyboard 400 and display 103 while at the same time providing a set of keys 401 which are relatively easy for the user to select and depress. Specifically, large bevels 402 are formed in the keyboard around each key, thereby providing space for a user's thumb as keys are depressed. In the embodiment shown in FIG. 4, the bevels are made as large as possible given the size constrains of the keyboard (i.e., they are formed such that the edges of each bevel are substantially adjacent to one another as indicated at intersection point 403).

FIG. 5 an exemplary key 501 from a side view. As shown in FIG. 5, a spacing 502 is provided between the key and the remainder of the keyboard 505 to allow the key to be depressed more easily. FIG. 5 also illustrates a connection unit 503 for connecting the key 501 to the keyboard 505. The connection unit 503 holds the key in place on the keyboard and applies an upward force to keep the top of the key positioned substantially co-planar with the top of the keyboard when not depressed (as indicated by the dashed line). Various known types of connection mechanisms for connecting keys to a keyboard may be used while still complying with the underlying principles of the invention. Moreover, the top surface of the key 501 need not be completely co-planar with the remainder of the keyboard 505 while still complying with the underlying principles of the invention.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Throughout the foregoing description, for the purposes of explanation, numerous specific details were set forth in order to provide a thorough understanding of the invention. It will be apparent, however, to one skilled in the art that the invention may be practiced without some of these specific details. For example, while the embodiments described above employ specific techniques for highlighting glyphs on keys/control elements, the underlying principles of the invention are not limited to any particular glyph highlighting mechanism. Accordingly, the scope and spirit of the invention should be judged in terms of the claims which follow.

What is claimed is:

1. A data processing device comprising:
a body having a memory for storing program code and data and a processor for processing the program code and data, the body further comprising a keyboard defining a first plane, the keyboard having a plurality of keys selectable by a user;
a display having a surface defining a second plane, the display moveably coupled to the data processing device to move from a first position in which the display covers the keyboard to a second position in which the keyboard is exposed, wherein the first plane and the second plane remain substantially parallel as the display is moved from the first position to the second position; and
wherein the keyboard comprises a plurality of holes formed in the body, and a corresponding plurality of keys operatively coupled to the body and immersed within each one of the holes, wherein the width and length of each hole is sized to provide sufficient spacing to accommodate the tip of a user's thumb as a key is depressed by the user into the hole.

2. The data processing device as in claim 1 wherein for a key having a width and/or length of N, the bevel of each hole is sized to have a corresponding width and/or length of at least M×N

3. The data processing device as in claim 2 wherein N=______ and M=______.

4. The data processing device as in claim 1 wherein each hole has a depth sized such that the top surface of each key is approximately co-planar with the second plane.
